(19) United States
(12) Patent Application Publication
(10) Pub. No.: US 2017/0286458 A1
(43) Pub. Date: Oct. 5, 2017

(54) Computer and Database Management Method

(71) Applicant: Hitachi, Ltd., Chiyoda-ku, Tokyo (JP)

(72) Inventors: Satoru WATANABE, Tokyo (JP); Yoshiki KUROKAWA, Tokyo (JP); Yoshitaka TSUJIMOTO, Tokyo (JP)

(21) Appl. No.: 15/510,756

(22) PCT Filed: Feb. 25, 2015
(86) PCT No.: PCT/JP2015/055342

§ 371 Date: Mar. 13, 2017

(51) Int. Cl. G06F 17/30

(52) U.S. Cl. CPC G06F 17/30306; G06F 17/30979; G06F 17/30463

(57) ABSTRACT

A computer comprising a processor and a memory and providing a database management unit for managing a database, said computer having a device that is connected to the processor via an interface and that comprises: at least one nonvolatile semiconductor storage device which has a plurality of nonvolatile semiconductor memories and which stores a database; at least one database calculation module which reads the database from the nonvolatile semiconductor storage device and performs calculations in the database; and a switch which connects the interface to the nonvolatile semiconductor storage device and the database calculation module.

### BACKGROUND

The present invention relates to a computer system including a flash module that stores data and a database operation circuit, and to a database operation circuit.

In recent years, techniques to add database operation functionality to information storage devices that use a semiconductor memory such as flash memory (hereinafter referred to as a solid state drive (SSD) or a flash module) have been in development. SSDs including database operation functionality have, in addition to the conventional function of reading and writing data, the function of executing a database function, which conventionally would have been executed by the CPU of a server.

In Non-Patent Document 1, a user program can be executed by a CPU of an SSD, and the CPU of the SSD executes a selection query of Microsoft SQL Server (R), which is a database product by Microsoft. In Non-Patent Document 2, a computing module using system-on-chip technology is disposed inside the SSD, and a database operation is performed on data read from the flash memory.

By these techniques, the amount of data transmitted between the server and the SSD is reduced. In general, the data transmission band in the SSD is greater than the data transmission band between the server and the SSD, and thus, the effect of improving performance can be attained. Non-Patent Documents 1 and 2 disclose evaluation results indicating that by using SSDs including database operation functionality, system performance is improved. Non-Patent Document 2 discloses evaluation results indicating that by disposing a computing module using system-on-chip technology inside the SSD, energy efficiency is improved compared to a technique using a CPU.

Patent Document 1 discloses a device and apparatus that store and search data. The device of Patent Document 1 includes at least one magnetic storage medium configured so as to store target data and at least one reconfigurable logic device, and this reconfigurable logic device includes an FPGA joined to at least one magnetic storage medium, the device being configured so as to be able to read a continuous stream of the target data and being configured as desired using a template or so as to match the search type and data being searched.

### RELATED ART DOCUMENTS

Patent Document 1: U.S. Pat. No. 6,711,558 Specification
Non-Patent Document 1: Jaeyoung Do, Yang-Suk Kee, Jignesh M. Patel, Chanik Park, Kwanghyun Park, David J. Dewitt, “Query Processing on Smart SSDs: Opportunities and Challenges”, SIGMOD 2013.
Non-Patent Document 2: Sungchan Kim, Hyunok Oh, Chanik Park, Sangyeun Cho, Sang-Won Lee, “Fast, Energy Efficient Scan inside Flash Memory SSDs”, ADMS 2011.

### SUMMARY

Non-Patent Documents 1 and 2 have a fixed relationship between the flash module and the database operation unit. Thus, there were cases in which if either the flash module or the database operation unit were to malfunction, then the device could not be used. Also, if the database operation unit is primarily used for database processing, then depending on conditions, it might be faster for the host computer to perform database processing. For example, in partial searches where the index is only present in the host computer, there are cases in which it is faster for the host computer to perform processing than for the database operation unit to perform processing.

The present invention takes into account the above-mentioned problems, and an object thereof is to provide a computer that includes a flash module and a database operation unit, by which it is possible to improve database processing performance while ensuring redundancy.

A representative aspect of the present disclosure is as follows. A computer that provides a database management unit that manages a database, the computer comprising: a processor; a memory; and a device connected to the processor through an interface, wherein the device comprises: a non-volatile semiconductor storage device including a plurality of non-volatile semiconductor memories, and storing the database; a database operation module that reads in the database from the non-volatile semiconductor storage device and performs an operation on the database; and a switch that connects the interface with the non-volatile semiconductor storage device and the database operation module.

According to the present invention, it is possible to improve computer performance while ensuring redundancy in a computer system including a device in which a non-volatile semiconductor storage device is separate from a database operation module.

### BRIEF DESCRIPTION OF THE DRAWINGS

FIG. 1 is a block diagram showing an example of a computer system including a flash card according to a first embodiment of this invention.

FIG. 2 is a function block diagram showing an example of the DBMS according to the first embodiment of this invention.

FIG. 3 shows an example of the table area management information according to the first embodiment of this invention.

FIG. 4 shows an example of the table structure information according to the first embodiment of this invention.

FIG. 5 shows an example of the index management information according to the first embodiment of this invention.

FIG. 6 shows an example of the database statistic information according to the first embodiment of this invention.

FIG. 7 shows an example of the database operation module information according to the first embodiment of this invention.

FIG. 8 shows an example of an SQL script according to the first embodiment of this invention.

FIG. 9 is a flowchart showing an example of the process performed in the execution plan generation unit according to the first embodiment of this invention.

FIG. 10 is a flowchart showing an example of a process performed by the database operation command scheduling unit according to the first embodiment of this invention.

FIG. 11 shows an example of information included in the database operation command according to the first embodiment of this invention.

FIG. 12 is a block diagram showing an example of the database operation module according to the first embodiment of this invention.

FIG. 13 is a flowchart showing an example of a process performed by the database operation control unit 81 of the database operation module according to the first embodiment of this invention.

FIG. 14 is a flowchart showing an example of a process performed by the data READ processing unit 60 of the database operation module according to the first embodiment of this invention.

FIG. 15 is a flowchart showing an example of a process performed by the data READ processing unit 60 of the database operation module according to the first embodiment of this invention.

FIG. 16 is a flowchart showing an example of a process performed by the database operation control unit 81 of the database operation module according to the first embodiment of this invention.

FIG. 17 is a flowchart showing an example of a process performed by the database operation control unit of the database operation module according to the first embodiment of this invention.

FIG. 18 is a block diagram showing an example of the database operation circuit according to the first embodiment of this invention.

FIG. 19 is a block diagram showing one example of a computer system that includes flash cards according to a second embodiment of this invention.

### DETAILED DESCRIPTION OF EMBODIMENTS

Below, embodiments of the present invention will be explained with reference to affixed drawings.

### Embodiment 1

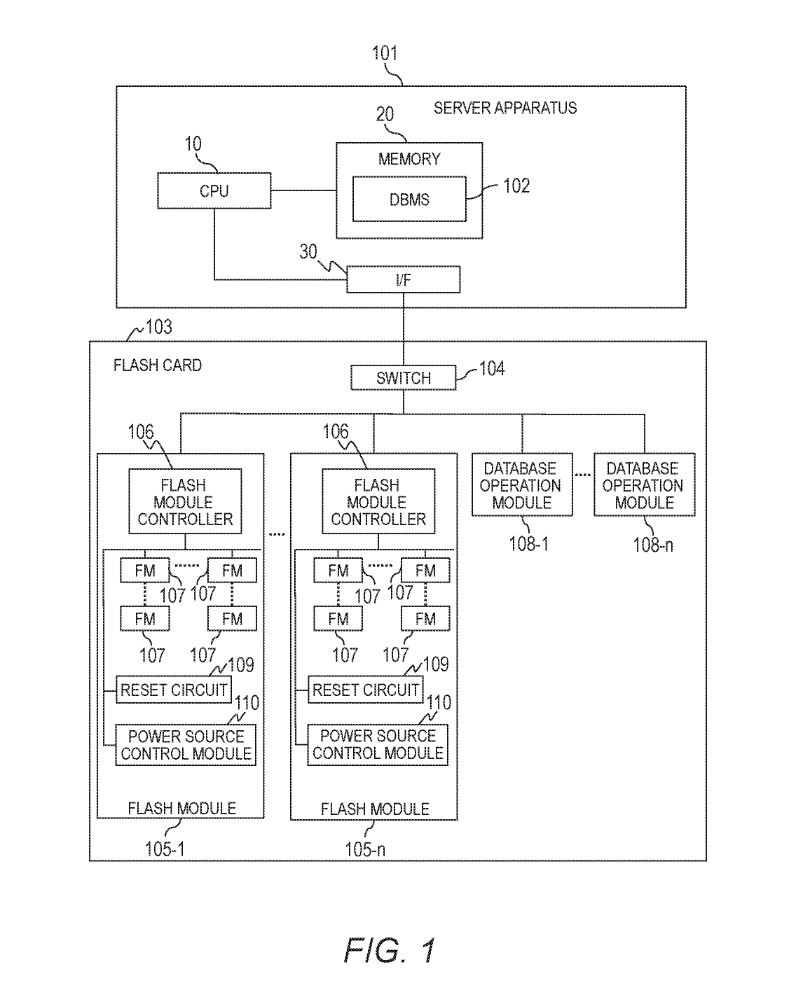

FIG. 1 is a block diagram showing an example of a computer system including a flash card 103 (storage device) of the present invention. As shown in FIG. 1, a database management system 102 (hereinafter referred to as a DBMS) operates in the server apparatus 101.

The DBMS 102 is a program that is loaded into the memory 20 of the server apparatus 101, and executed by the CPU 10. The server apparatus 101 is connected to a network (not shown), receives a database processing request from a client computer (not shown), and sends database processing results as a response to the client computer.

The server apparatus 101 comprises a flash card 103 as a device including an operation circuit that can execute a database operation in addition to storing data of the database. The flash card 103 of the present invention functions as a storage device including support functionality for the database process. The server apparatus 101 and the flash card 103 are connected through an interface 30 (“I/F” in the drawing). The server apparatus 101 can include a storage device (not shown) that stores the DBMS 102 program.

The flash card 103 includes a plurality of flash modules 105-1 to 105-n, a plurality of database operation modules 108-1 to 108-n, and a switch 104 that connects the flash modules 105-1 to 105-n and the database operation modules 108-1 to 108-n to the interface 30.

The switch 104 is connected to the interface 30, which complies with a standard such as PCI Express or SAS, for example.

Below, the flash modules 105-1 to 105-n will be collectively referred to with the reference character 105 without suffixes. Additionally, the database operation modules 108-1 to 108-n will also be collectively referred to with the reference character 108 without suffixes. This similarly applies to other components as well.

The switch 104 selects where to transmit the data on the basis of the transmission destination included in the transmitted/received data. The server apparatus 101 can communicate with the flash module 105 and the database operation module 108 through the switch 104. Also, the flash module 105 can communicate with the database operation module 108 through the switch 104.

The flash module 105 includes a plurality of flash memories 107 (“FM” in the drawing), a flash module controller 106 that controls access to the flash memory 107, a reset circuit 109 that initializes the flash module controller 106 and the like, and a power source control unit 110 that controls power supply to the flash module 105. The reset circuit 109 and the power source control unit 110 of the flash module 105 can be controlled from the server apparatus 101.

An example was illustrated in which the flash module 105 is comprise d of flash memories 107, but the memory is not limited to being a flash memory 107 as long as a non-volatile semiconductor storage device is used, and a phase-change memory or the like can be used, for example.

The database operation module 108 performs a database operation by reading data in a parallel manner from the plurality of flash modules 105-1 to 105-n on the basis of a command from the DBMS 102. The configuration of the database operation module 108 will be described later.

The database operation module 108 can perform a database operation in a parallel manner on the basis of a command from the DBMS 102.

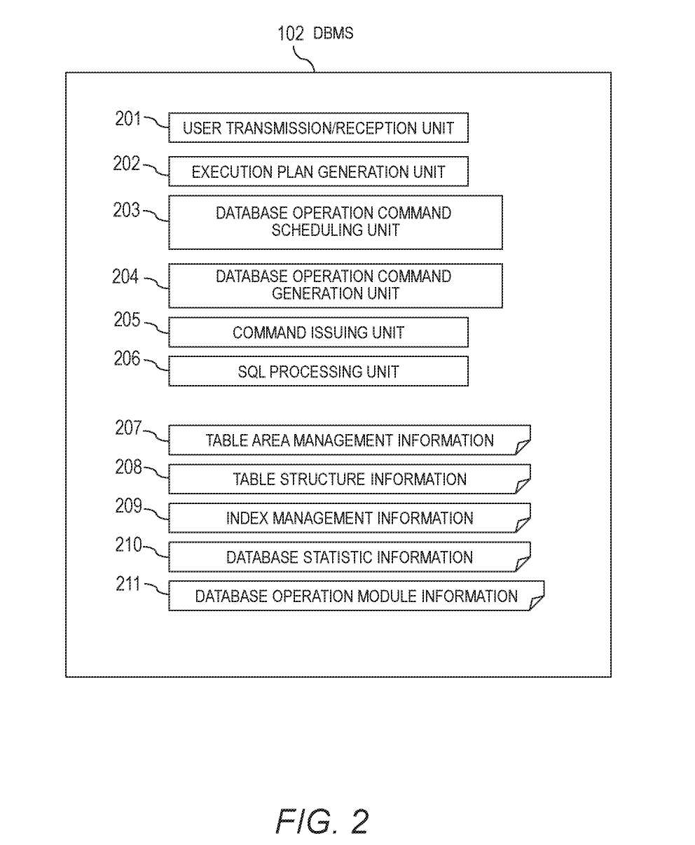

FIG. 2 is a function block diagram showing an example of the DBMS 102. The DBMS 102 includes, as functional units constituting the database management unit, a user transmission/reception unit 201, an execution plan generation unit 202, a database operation command scheduling unit 203, a database operation command generation unit 204, a command issuing unit 205, and an SQL processing unit 206.

The DBMS 102 includes, as management information, table area management information 207, table structure information 208, index management information 209, database statistic information 210, and database operation module information 211.

Information such as programs realizing the respective functions of the DBMS 102 can be stored in a storage device such as a non-volatile semiconductor memory, a hard disk drive, or a solid state drive (SSD), or in a computer-readable non-transitory data storage medium such as an IC card, an SD card, or a DVD.

The user transmission/reception unit 201 receives a database processing request including an SQL script from the client computer (not shown), extracts the SQL script from the processing request, and transmits the SQL script to the execution plan generation unit 202. The user transmission/reception unit 201 transmits to the client computer (not shown) the database processing results received from the SQL processing unit 206 or the database operation module 108.

The execution plan generation unit 202 analyzes the SQL script received from the user transmission/reception unit 201, and when performing search processing, determines whether to perform a complete search or a partial search of the database stored in the flash card 103. As described later, the execution plan generation unit 202 selects partial search if an index is stored in the flash card 103 for the database being searched, and if the index is not stored in the flash card 103, then the execution plan generation unit 202 selects complete search.

If performing a partial search or an updating process, the execution plan generation unit 202 transmits the SQL text to the command issuing unit 205 as an SQL command. On the other hand, when performing a complete search, the database operation module 108 performs the database operation by accessing the plurality of flash modules 105-1 to 105-n in parallel, and thus, the execution plan generation unit 202 transmits the SQL text to the database operation command scheduling unit 203.

The database operation command scheduling unit 203 analyzes the SQL script received from the execution plan generation unit 202 and determines the multiplicity (number of commands distributed, destination of distribution, etc.) of the database operation module 108, which executes a complete search in a parallel manner. The database operation command scheduling unit 203 determines the database operation module 108 to perform the complete search as well as the multiplicity as described later, and issues this determination along with the SQL text as a notification to the database operation command generation unit 204.

The database operation command generation unit 204 generates a database operation command 1101 to be executed by the database operation module 108 and transmits the database operation command to the command issuing unit 205 according to the schedule received from the database scheduling unit 203.

The command issuing unit 205 transmits the database operation command received from the database operation command generation unit 204 to the database operation module 108. If the command issuing unit 205 receives a notification from the execution plan generation unit 202 that a table search using an index is to be performed, then the command issuing unit generates a READ command for reading a top node address 503 in the table area to be searched, and transmits the READ command to the flash module 105.

Also, if the command issuing unit 205 receives a notification from the execution plan generation unit 202 that updates or additions are to be made to the database, then the command issuing unit generates a prescribed command for the table to be processed, and transmits the generated command to the SQL processing unit 206 and executes a database operation at the DBMS 102.

The SQL processing unit 206 executes the received command during partial search, an updating process, or an adding process, and executes the database operation by accessing the flash module 105 of the flash card 103. The SQL processing unit 206 transmits the results of the database operation to the user transmission/reception unit 201.

The respective functions of the DBMS 102 including the user transmission/reception unit 201, the execution plan generation unit 202, the database operation command scheduling unit 203, the database operation command generation unit 204, the command issuing unit 205, and the SQL processing unit 206 are loaded to the memory 20 as programs. The CPU 10 operates as a functional unit that provides prescribed functions by executing processes according to programs in respective functional units. For example, the CPU 10 functions as the DBMS 102 by executing a process according to a database management program. The same applies for other programs. Additionally, the CPU 10 also operates as functional units providing, respectively, functions of a plurality of processes executed by respective programs. The computer and the computer system are a device and system including these functional units.

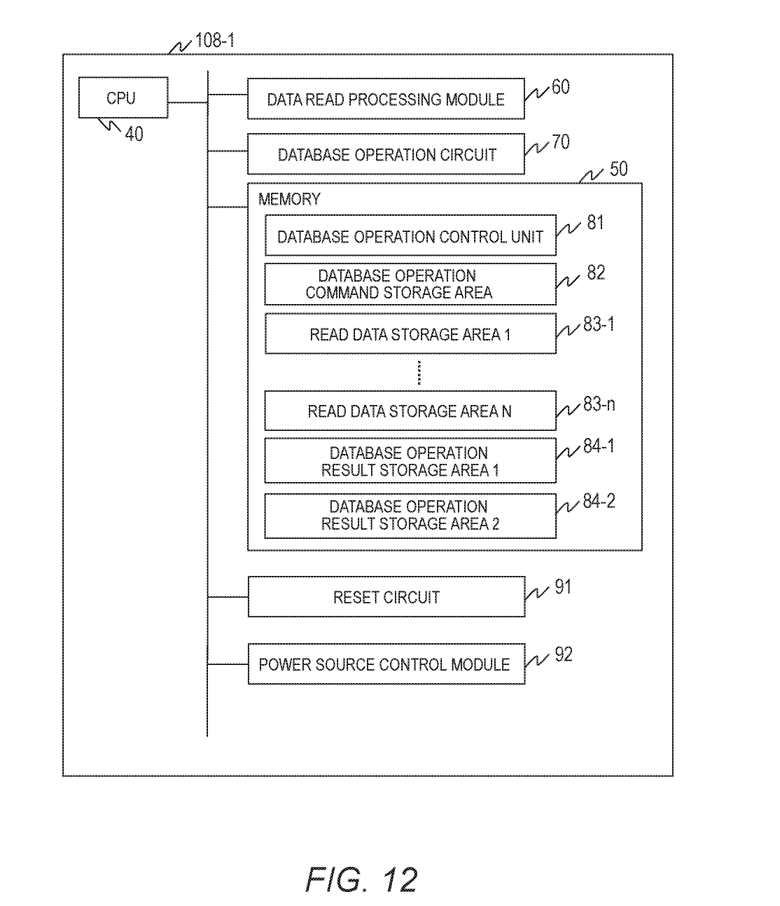

FIG. 12 is a block diagram showing an example of the database operation module 108-1. The database operation module 108-1 includes a CPU 40 that executes prescribed processes, a memory 50 that stores data and programs, a data READ processing unit 60 that reads data in a parallel manner from the plurality of flash modules 105-1 to 105-n, a database operation circuit 70 that executes a data operation on the read in data, a reset circuit 91 that initializes the CPU 40 and the like, and a power source control unit 92 that controls the power supplied to the database operation module 108. The reset circuit 91 and the power source control unit 92 can be controlled from the server apparatus 101. The database operation modules 108-1 to 108-n have similar configurations, and thus, only the database operation module 108-1 will be described, with redundant descriptions being omitted.

A database operation control unit 81 is loaded to the memory 50 and executed by the CPU 40. The memory 50 has set therein a database operation command storage area 82, READ data storage areas 83-1 to 83-n, and database operation result storage areas 84-1 and 84-2 as areas managed by the database operation control unit 81.

The database operation result storage areas 84-1 and 84-2 are set according to the multiplicity of the database operation module 108, and in the example of FIG. 12, the multiplicity is “2”. The READ data storage areas 83-1 to 83-n can be set according to the number of flash modules 105-1 to 105-n.

The database operation control unit 81 communicates with the server apparatus 101 and controls the data READ processing unit 60 and the database operation circuit 70. When the database operation control unit 81 receives a command from the server apparatus 101, the command is stored in the database operation command storage area 82 and transmitted to the data READ processing unit 60.

The data READ processing unit 60 analyzes the received database operation command and divides the access area to be searched into prescribed smaller areas. The data READ processing unit 60 generates a plurality of READ commands to the divided small areas, transmits the READ commands to the flash modules 105-1 to 105-n, and reads the database to be searched in a parallel manner.

Here, if the prescribed access area to be searched is 8 MB, the data READ processing unit 60 divides the access area into 64 small areas, each of which is 128 KB, and generates READ commands for the small areas.

The data READ processing unit 60 sequentially reads in data from the flash modules 105-1 to 105-n for which reading has been completed, and sequentially stores the data in the READ data storage areas 83-1 to 83-n. The database operation control unit 81 notifies the database operation circuit 70 of the READ data storage areas 83-1 to 83-n for which reading has been completed and executes the database operation command.

The database operation circuit 70 stores the processing results of the database operation command to the database operation result storage area 84-1 or 84-2.

The database operation control unit 81 transmits, to the DBMS 102 of the server apparatus 101, the content of the database operation result storage area 84-1 or 84-2 in which the database operation results were stored.

By the above configuration, when the database operation module 108 receives the database operation command, it divides the access area of the database to be searched into small areas and generates a plurality of READ commands. The data READ processing unit 60 issues READ commands for the respective small areas of the one or more flash modules 105 and reads the data in a parallel manner.

The database operation control unit 81 executes the database operation command in the database operation circuit 70 in the order in which reading of the access areas is completed and transmits the database operation results to the DBMS 102 of the server apparatus 101.

By the configuration above, the data READ processing unit 60 performs a reading process in parallel in the flash module for each of the plurality of small areas, and the data READ processing unit 60 operates separately from the database operation circuit 70, enabling improvement in database processing performance by the reading process and the database operation process being executed in parallel.

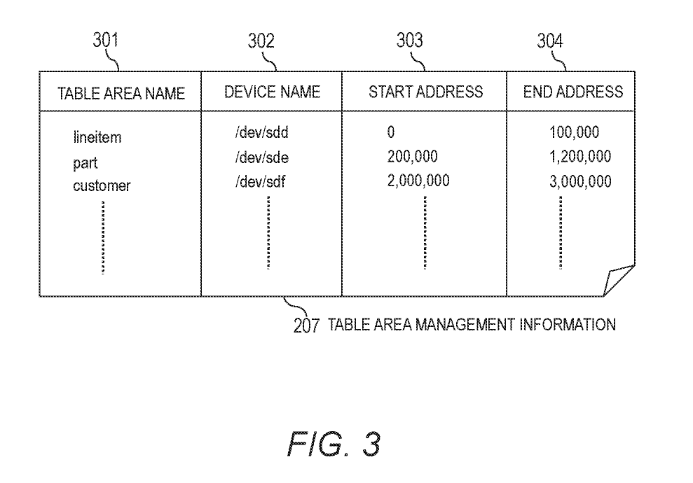

FIG. 3 shows an example of the table area management information 207. The table area management information 207 is information for managing a table of a database stored in the flash card 103. The table area management information 207 is generated by the DBMS 102.

The table area management information 207 includes in one entry table area names 301 where names of the tables of the database are stored, device names 302 where names (or identifiers) are stored of the flash modules 105 where the tables are stored, and start addresses 303 and end addresses 304 that are assigned to the flash modules 105.

The start address 303 and the end address 304 can use a logical block address (LBA) assigned to the flash module 105.

The table area management information 207 is generated by the DBMS 102. The DBMS 102 can generate the table area management information 207 at a prescribed timing such as during startup by acquiring a start address 303 and an end address 304 for each device name 302 from an OS (not shown) of the server apparatus 101.

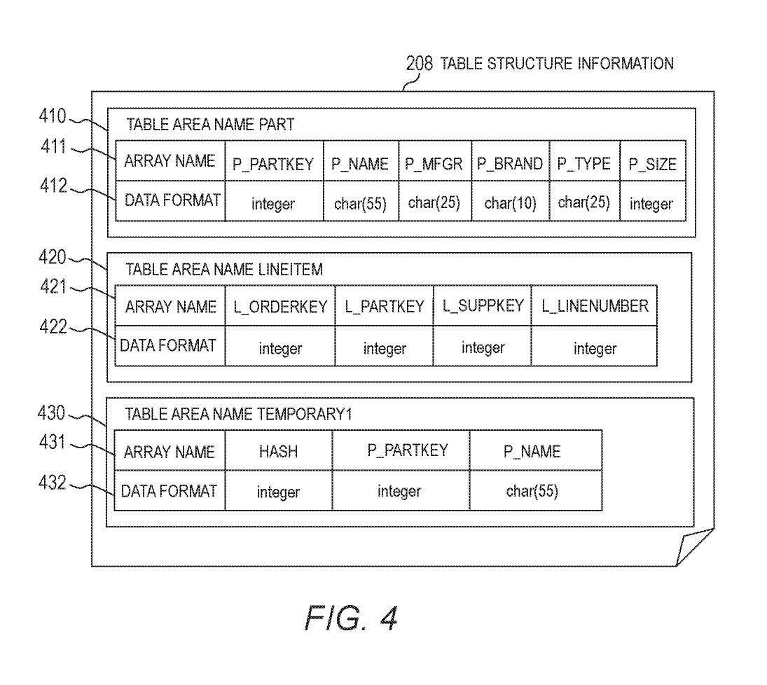

FIG. 4 shows an example of the table structure information 208. The table structure information 208 includes the table area names 410, 420, and 430 that store the names of the tables, array names 411, 421, and 431 that store the names of the arrays (or fields) of the respective tables, and data formats 412, 422, and 432 that store the data format of each array.

In the example shown, the table area name 410 stores the table definition of “PART”, the table area name 420 stores the table definition of “LINEITEM”, and the table area name 430 stores the table definition of “TEMPORARY1”.

The table structure information 208 is generated by the DBMS 102. The DBMS 102 sets the format of each array name (field) with reference to the data of the table area names 410, 420, and 430 from the flash card 103 and sets the table structure information 208 at a prescribed timing such as during startup.

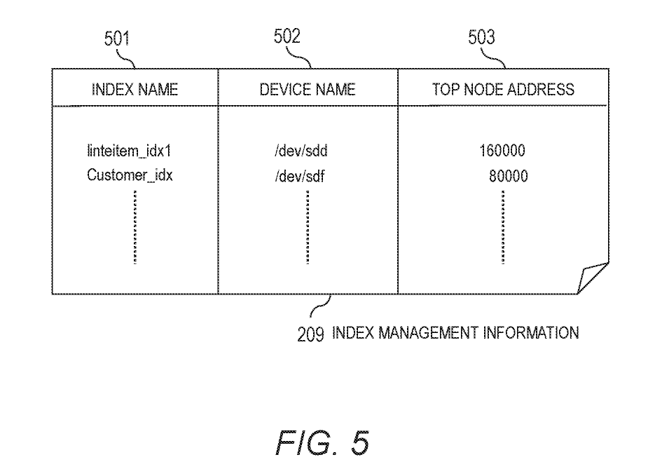

FIG. 5 shows an example of the index management information 209. The index management information 209 includes in one entry index names 501 where names of indices are stored, device names 502 where names (or identifiers) are stored of the flash modules 105 where the indices are stored, and top node addresses 503 where the root node addresses of the indices in the flash modules 105 are stored. The top node addresses 503 can use an LBA assigned to the flash module 105.

The index management information 209 is generated by the DBMS 102. The DBMS 102 may generate the index management information 209 at a prescribed timing such as during startup by acquiring a root node address of the index name 501 for each device name 502 from an OS (not shown) of the server apparatus 101. Alternatively, the index information may be issued as a notification to the DBMS 102 from an input device (not shown) of the server apparatus 101.

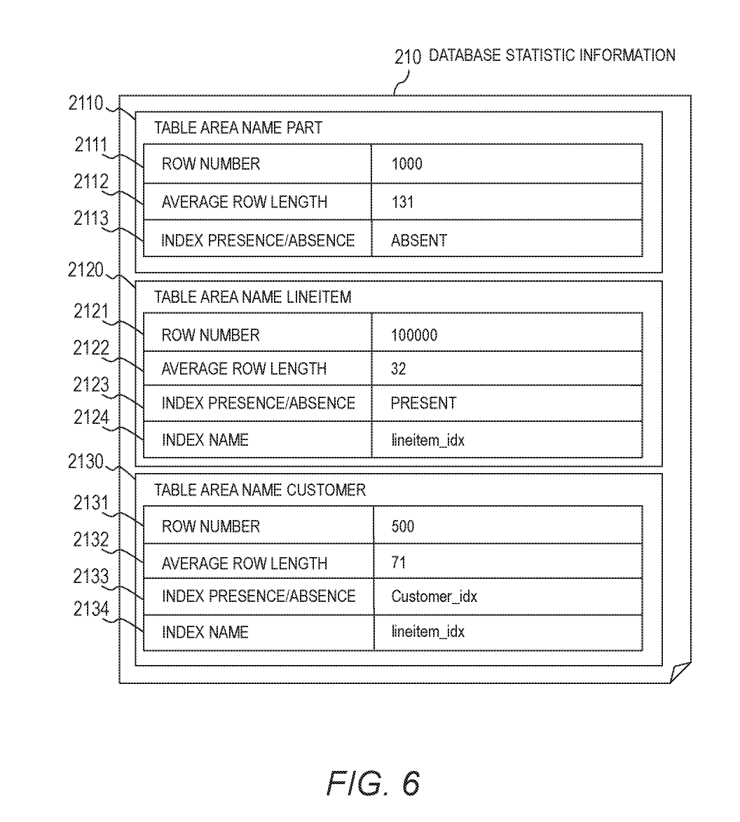

FIG. 6 shows an example of the database statistic information 210. The database statistic information 210 includes table area names 2110, 2120, and 2130 where the names of the tables are stored, row numbers 2111, 2121, and 2131 where the row numbers are stored, average row lengths 2112, 2122, and 2132 where the average row lengths of the tables are stored, index presence indicators 2113, 2123, and 2133 where indications of the presence or absence of indices in the tables are stored, and index names 2124 and 2134 where the names of the indices corresponding to the tables are stored if an index is present.

In the example shown, the table area name 2110 stores statistical information of “PART”, the table area name 2120 stores statistical information of “LINEITEM”, and the table area name 2130 stores the statistical information of “CUSTOMER”.

The database statistic information 210 is generated by the DBMS 102. The DBMS 102 can calculate the row numbers and the row lengths with reference to the data of the table area names 2110, 2120, and 2130 from the flash card 103 and set the database statistic information 210 at a prescribed timing such as during startup.

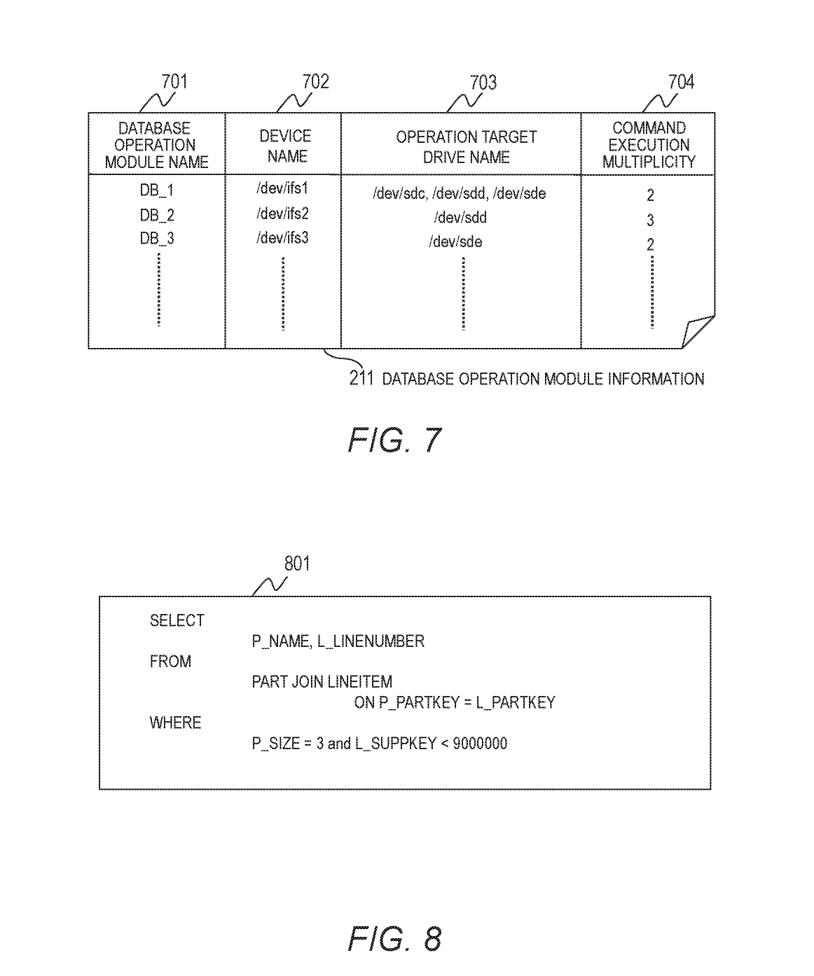

FIG. 7 shows an example of the database operation module information 211. The database operation module information 211 includes in one entry a database operation module name 701 that stores the name (or identifier) of the database operation module 108, a device name 702 that stores the device name (or identifier) of the database operation module 108, an operation target drive name 703 that stores the name (or identifier) of the flash module 105 allocated to the database operation module 108, and a command execution multiplicity 704 that stores the multiplicity of command execution by the database operation module 108.

One database operation module 108 comprises one or more flash modules 105 allocated thereto, and the operation target drive name 703 has stored therein one or more device names.

The database operation module information 211 is generated by a manager or the like of the server apparatus 101. A manager can allocate to the operation target drive name 703 the flash modules 105-1 to 105-n accessed for each database operation module 108. Alternatively, a configuration may be adopted in which the DBMS 102 allocates to the operation target drive name 703 the flash modules 105-1 to 105-n accessed for each database operation module 108.

The command execution multiplicity 704 indicates the number of database operation commands executable simultaneously in the database operation circuit 70 of the database operation module 108. The database operation module 108 suspends execution of the database operation command if the number of database operation commands received exceeds a value set in the command execution multiplicity 704.

FIG. 8 shows an example of an SQL script 801. In the example shown, a process is executed in which “PART” and “LINEITEM” of a table are searched and joined. When the user transmission/reception unit 201 of the DBMS 102 of the server apparatus 101 receives the SQL script 801 from a client computer (not shown), it sends the SQL script 801 to the execution plan generation unit 202 and executes the database operation as described later.

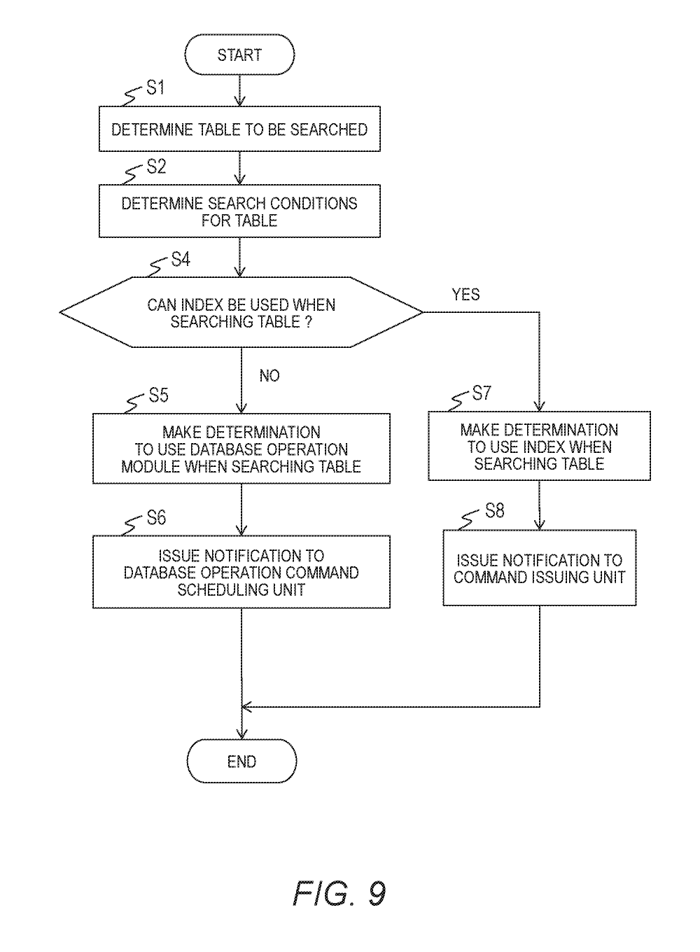

FIG. 9 is a flowchart showing an example of the process performed in the execution plan generation unit 202. This process is executed when the execution plan generation unit 202 receives the SQL script 801 including search processes from the user transmission/reception unit 201.

The execution plan generation unit 202 reads in the received SQL script 801 and determines the table to be searched (S1). The execution plan generation unit 202 reads in the received SQL script 801 and determines the search conditions by which the search is to be performed (S2).

Next, the execution plan generation unit 202 refers to the database statistic information 210 to determine whether an index is present in the table to be searched (S4). If an index is present in the table to be searched, the execution plan generation unit 202 determines that the type of search is partial search, and progresses to step S7.

On the other hand, if an index is not present in the table to be searched, the execution plan generation unit 202 determines that the type of search is complete search, and progresses to step S5.

In step S5, the execution plan generation unit 202 determines that the database operation module 108 should be used for table search. Then, in step S6, the execution plan generation unit 202 sends the SQL script 801 to the database operation command scheduling unit 203 as a notification.

On the other hand, in step S7 for partial search, the execution plan generation unit 202 determines that the index should be used for table search. Then, in step S8, the execution plan generation unit 202 sends the SQL script 801 to the command issuing unit 205 as a notification.

By the process above, the DBMS 102 reads in the received SQL script 801 and depending on the presence or absence of an index in the table to be searched, determines whether to perform a partial search or a complete search. If an index is present in the flash module 105, the execution plan generation unit 202 issues the SQL script 801 to the command issuing unit 205 as a notification in order to execute a partial search by which the DBMS 102 itself performs the database operation.

On the other hand, if an index is not present in the flash module 105, the execution plan generation unit 202 issues the SQL script 801 to the database operation command scheduling unit 203 as a notification in order for the database operation module 108 to execute a complete search.

If the execution plan generation unit 202 receives from the user transmission/reception unit 201 an SQL script 801 that has no search process, then similar to the partial search, the SQL script 801 is issued as a notification to the command issuing unit 205 and the process is executed in the DBMS 102.

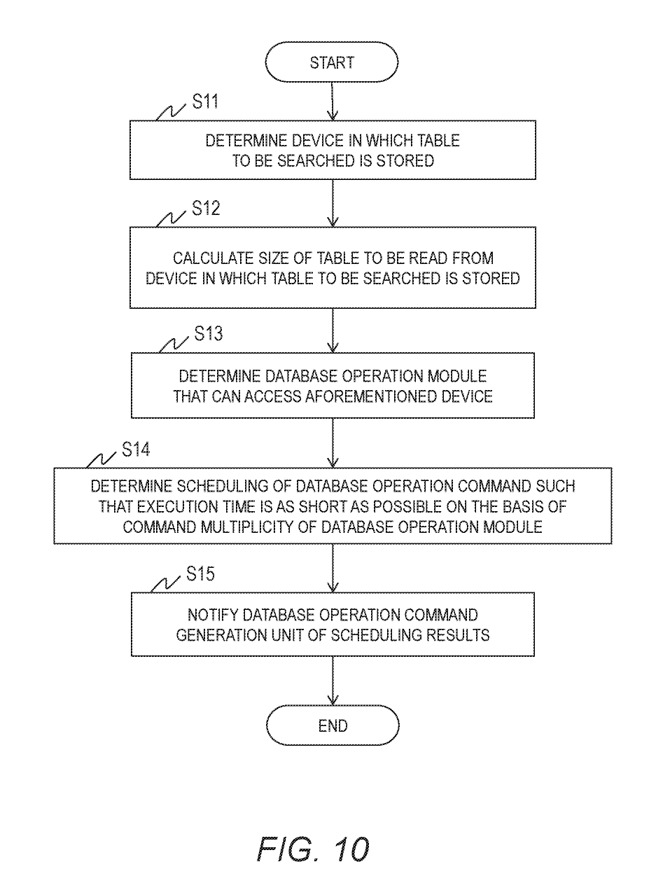

FIG. 10 is a flowchart showing an example of a process performed by the database operation command scheduling unit 203. This process is executed when the database operation command scheduling unit 203 receives the SQL script 801.

When the database operation command scheduling unit 203 receives the SQL script 801, it refers to the table area management information 207 and acquires the device name 302 of the flash module 105 that stores the table to be searched as the device to be accessed (S11).

The database operation command scheduling unit 203 refers to the table area management information 207 and acquires the start address 303 and the end address 304 of the flash module 105 to be accessed and calculates the size of the table to be read in (S12).

Next, the database operation command scheduling unit 203 refers to the database operation module information 211, and acquires the database operation module name 701 for which the device name of the flash module 105 to be accessed is included in the operation target drive name 703, and determines that the database operation is to be performed on the database operation module 108 including that name (S13).

In step S14, the database operation command scheduling unit 203 refers to the database operation module information 211 and acquires the command execution multiplicity 704 of the database operation module 108 for which reading in of the database is to be performed. Also, the database operation command scheduling unit 203 determines the scheduling of the database operation command such that the time required to perform the database process (execution time) is as short as possible, on the basis of the command execution multiplicity 704.

Here, when the time required for the database read in process in a plurality of database operation modules 108 and the execution time for the database process, which is the sum of the time required for the read-in process and the database operation when performing database operation, are equal or substantially equal among all database operation modules 108, then the execution time for the database process is deemed to be the shortest possible.

In step S15, the database operation command scheduling unit 203 issues the scheduling for database operation determined for each database operation module 108 as a notification to the database operation command generation unit 204.

By the process above, when performing a complete search on the database, one or more database operation modules 108 cause the database operation for executing the database process (read-in process+database operation) to be scheduled.

The scheduling is generated on the basis of the SQL script 801 received by the database operation command scheduling unit 203, and includes the database operation module 108 to be accessed, the start address and end address of the database operation module 108 to be accessed, and the database operation. The database operation includes data search conditions, a search condition joining method, and data extraction conditions, as will be described later.

Here, the scheduling generated by the database operation command scheduling unit 203 determines the database operation module 108 to be searched from the SQL script 801, and determines the access range for each database operation module 108.

The database operation command scheduling unit 203 generates the access range for each database operation module 108 for which such determination was made, and generates scheduling for each prescribed access area (size). The scheduling is generated according to the number of database operation modules 108 if the database covers a plurality of database operation modules 108.

In the present embodiment, as one example, the prescribed access area is set to 8MB, and the database operation command scheduling unit 203 divides the entire access range for the flash module 105 to be accessed into 8MB segments and generates scheduling for reading in of the segments.

If the database operation command scheduling unit 203 divides the entire access range of the flash module 105 into a plurality of prescribed access areas, then it is possible to schedule the remaining areas that are less than 8 MB.

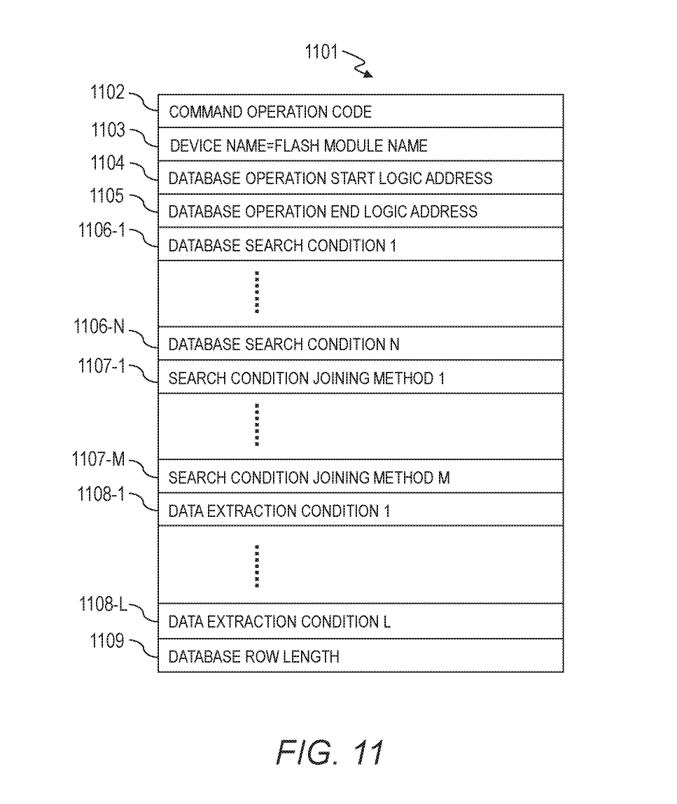

FIG. 11 shows an example of information included in the database operation command 1101. The database operation command generation unit 204 generates a database operation command 1101 on the basis of the scheduling for each database operation module 108 received from the database operation command scheduling unit 203 and transmits the database operation command to the command issuing unit 205.

The database operation command 1101 includes a command operation code 1102, a device name 1103 (flash module name), a database operation start logic address 1104, a database operation end logic address 1105, data search conditions 1106-1 to 1106-N, search condition joining methods 1107-1 to 1107-M, data extraction conditions 1108-1 to 1108-L, and a database row length 1109.

The command operation code 1102 is code indicating the database operation command 1101. The device name 1103 (flash module name) has set therefor identifiers of flash modules 105-1 to 105-n to be accessed.

The database operation start logic address 1104 is a logic address (LBA) at which the database operation starts, and an address allocated to the flash module 105 to be accessed is set therefor. The database operation end logic address 1105 is a logic address at which the database operation ends, and an address allocated to the flash module 105 to be accessed is set therefor.

The data search conditions 1106-1 to 1106-N have set therefor conditions for searching data in the database. The conditions for searching the data in the database include a storage position for data to be compared, the values of data to be compared, and a comparison method. A condition whereby data stored from the 0th byte to the 7th byte of data in the database is compared to the value “10” of data to be compared to determine whether the value is larger, for example, is included.

The search condition joining methods 1107-1 to 1107-M are defined as methods in which the data search conditions 1106-1 to 1106-N are joined by AND or OR. The search condition joining method 1107-1 includes a method in which the data search conditions are joined by AND or OR, such as in the following statement: (data search condition 1) AND (data search condition 2) OR (data search condition 3), for example.

The data extraction conditions 1108-1 to 1108-L have set therefor conditions for extracting data to be transmitted to the server apparatus 101 from data matching the data search conditions 1106-1 to 1106-N and the search condition joining methods 1107-1 to 1107-M. The data extraction condition 1108-1 has stored therein a condition whereby the 0th to 7th bytes of the database are extracted, for example. The database row length 1109 is set as the length of one row of the database.

One database operation command 1101 can include one or more data search conditions, one or more data search condition joining methods, and one or more data extraction conditions.

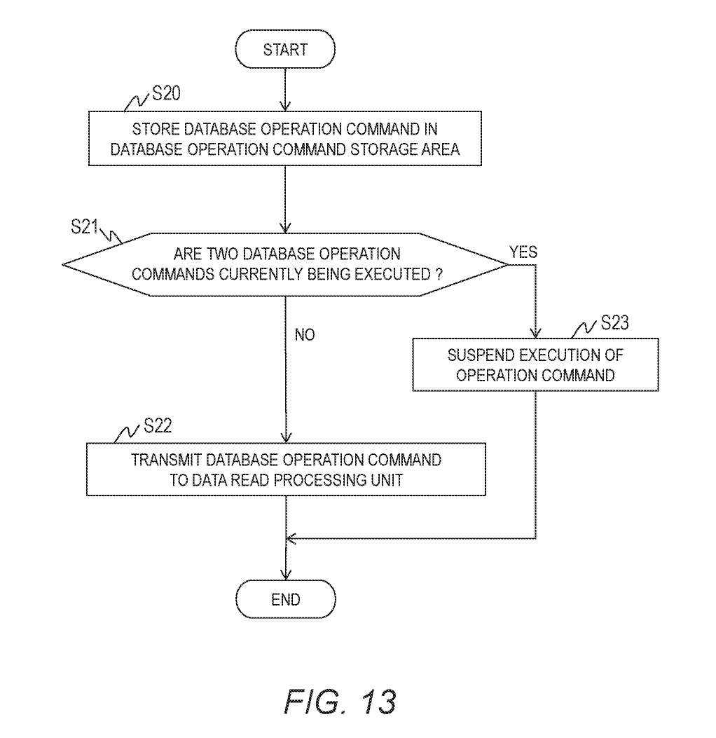

FIG. 13 is a flowchart showing an example of a process performed by the database operation control unit 81 of the database operation module 108. This flowchart is executed when the database operation module 108 receives the database operation command 1101 from the server apparatus 101.

When the database operation control unit 81 receives the database operation command 1101 from the server apparatus 101, the command is stored in the database operation command storage area 82 (S20). The database operation control unit 81 determines whether the number of database operation commands 1101 currently being executed in the database operation module 108 has reached multiplicity (S21). In the example shown, a case is depicted in which the multiplicity of the database operation module 108 is “2”. The multiplicity of the database operation module 108 may be determined by the database operation control unit 81 communicating with the DBMS 102 and acquiring the command execution multiplicity 704 from the database operation module information 211.

If the number of database operation commands 1101 currently being executed does not reach this multiplicity, then the process progresses to the step S22, and the database operation control unit 81 transmits the received database operation commands 1101 to the data READ processing unit 60, and starts execution of the database operation commands 1101.

On the other hand, if the number of database operation commands 1101 currently being executed does reach the multiplicity, then the process progresses to the step S23, and the database operation control unit 81 suspends execution of any new database operation commands 1101.

By the process above, when the database operation control unit 81 receives the database operation command 1101 from the server apparatus 101, the database operation command 1101 in the multiplicity set for the database operation module 108 can be executed.

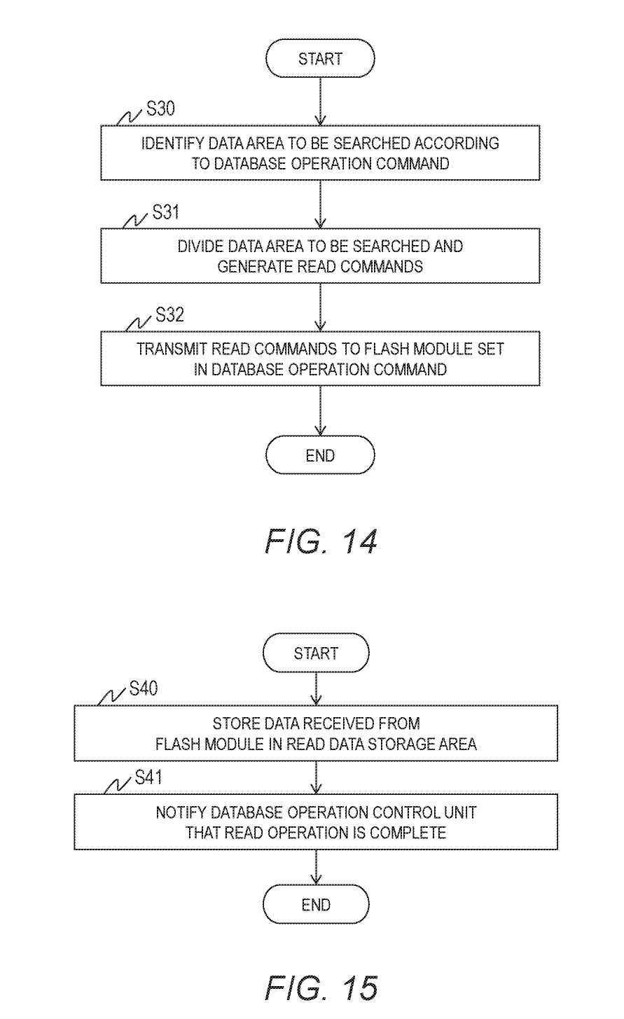

FIG. 14 is a flowchart showing an example of a process performed by the data READ processing unit 60 of the database operation module 108. This flowchart is executed when the data READ processing unit 60 receives the database operation command 1101 from the database operation control unit 81. In the present embodiment, the area to be searched has a size of 8 MB as described above, and the 8 MB data to be searched is divided into 128 KB segments, and 64 READ commands are created and transmitted to the flash module 105.

The data READ processing unit 60 analyzes the database operation command 1101 received from the database operation control unit 81 and determines the data areas to be searched. The database operation command 1101 shown in FIG. 11 includes the device name 1103, and the data READ processing unit 60 determines the flash modules 105-1 to 105-n to be accessed according to the device names 1103 (S30).

The data READ processing unit 60 divides the data area from the database operation start logic address 1104 to the database operation end logic address 1105 of the database operation command 1101 into a prescribed number (64, for example) of small areas (if the prescribed area is 8 MB, then the small areas would be 128 KB, for example), and generates a READ command for each small area (S31).

The data READ processing unit 60 transmits the plurality of READ commands generated for the respective small areas to the flash module 105 determined in step S30 (S32).

By the process above, the data area of the flash module 105 designated by the database operation command 1101 is divided into prescribed small areas, and a plurality of READ commands are generated for the respective small areas and transmitted to the flash module 105.

The flash module controller 106 of the flash module 105 executes the plurality of received READ commands in parallel, and reads in data from the plurality flash memories 107 in parallel. The flash module controller 106 transmits the read-in data to the database operation module 108 for each access area where reading in of the data has been completed.

FIG. 15 is a flowchart showing an example of a process performed by the data READ processing unit 60 of the database operation module 108. This process is executed when the database operation module 105 receives data from the flash module 108.

When the data READ processing unit 60 receives data from the flash module 105, it stores the data in the READ data storage areas 83-1 to 83-n set in the memory 50 (S40).

When the data READ processing unit 60 stores the received data in the READ data storage area 83, it issues a notification to the database operation control unit 81 that the READ operation is complete (S41). At this time, the data READ processing unit 60 issues, as a notification, identifiers or addresses of the READ data storage areas 83-1 to 83-n where the data is stored.

By the process above, the READ processing unit 60 stores the data received from the flash modules 105-1 to 105-n sequentially in the READ data storage areas 83-1 to 83-n, and notifies the database operation control unit 81 that reading in of data has been completed in the order of receipt of the data.

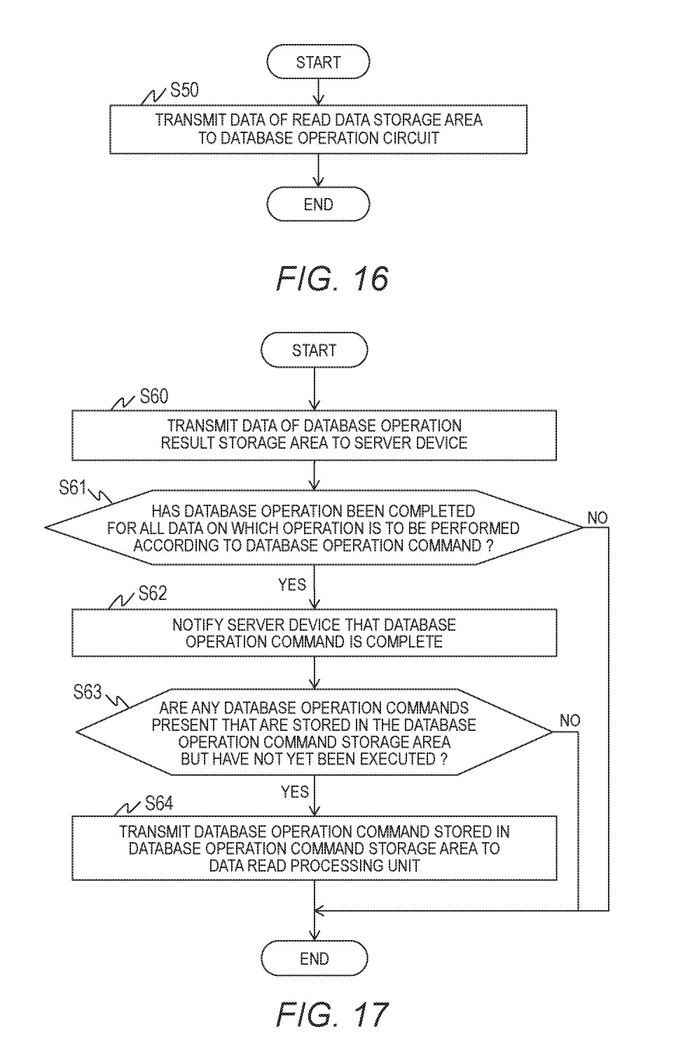

FIG. 16 is a flowchart showing an example of a process performed by the database operation control unit 81 of the database operation module 108. This process is executed when the database operation control unit 81 receives notification from the READ processing unit 60 that reading in of the data has been completed.

The database operation control unit 81 reads data in the database from the READ data storage areas 83 included in the notification received from the READ processing unit 60, and transmits the data to the database operation circuit 70 (S50).

In this manner, the database operation circuit 70 can execute a database operation on the received data in the order of completion of the READ command. When the database operation circuit 70 completes the database operation, it transmits the operation results to the database operation control unit 81.

FIG. 17 is a flowchart showing an example of a process performed by the database operation control unit 81 of the database operation module 108. This process is executed when the database operation control unit 81 receives the operation results from the database operation circuit 70.

When the database operation control unit 81 receives the operation results from the database operation circuit 70, it stores the operation results in the database operation result storage areas 84-1 and 84-2 and transmits the database operation results to the server apparatus 101 (S60).

Next, the database operation control unit 81 determines whether the database operation has been completed for all data in the database operation command 1101 on which the database operation is to be performed (S61). If the database operation has been completed for all data, then the process progresses to step S62. On the other hand, if the database operation has not yet been completed for all data, then the process ends and returns to step S21 in FIG. 13 and the above process is repeated.

In step S62, the database operation control unit 81 notifies the server apparatus 101 that execution of the database operation command has been completed.

Next, in step S63, the database operation control unit 81 determines whether there are any database operation commands 1101 stored in the database operation command storage area 82 that have not yet been executed. This process determines the presence or absence of database operation commands 1101 for which the database operation control unit 81 suspended execution in step S23 of the flowchart of FIG. 13.

If there are any commands for which execution was suspended, then the database operation control unit 81 progresses to step S64, and if not, ends the process. In step S64, the suspended database operation commands 1101 are transmitted to the READ processing unit 60 and the above process is executed.

By the process above, the database operation module 108 executes the received database operation commands 1101 in parallel within the multiplicity, and executes the database operations in the order of completion of read-in of data in the flash module 105.

The data READ processing unit 60 of the database operation module 108 divides the access area of the database operation command 1101 into prescribed small areas, and generates a plurality of READ commands for the respective small areas (128KB) to cause the flash module 105 to read in the data.

The flash module 105 comprises a plurality of flash memories 107, and thus, the flash module controller 106 can perform the read-in processes in parallel by the READ commands for the respective small areas. In this manner, it is possible to speed up the read-in operation in the flash module 105 and speed up the entire database process.

If the database covers a plurality of flash modules 105, the database operation module 108 can issue a READ command for each flash module 105, and thus, by executing read-in processes for the flash modules 105 in parallel, it is possible to speed up the read-in process.

Furthermore, the database operation module 108 can execute database operations starting with data for which the read-in process has been completed, and thus, it is possible to speed up database processing while preventing a decrease in processing performance due to pending data.

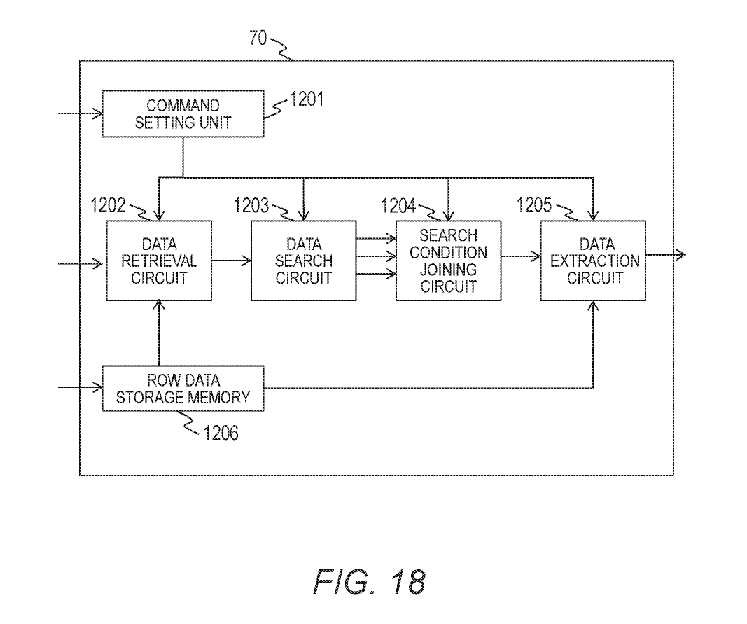

FIG. 18 is a block diagram showing an example of the database operation circuit 70. As shown in FIG. 18, the database operation circuit 70 includes a command setting unit 1201, a data retrieval circuit 1202, a data search circuit 1203, a search condition joining circuit 1204, a data extraction circuit 1205, and a row data storage memory 1206.

The command setting unit 1201 starts the process when it receives the database operation command 1101 from the database operation control unit 81. The command setting unit 1201 extracts necessary information from the received database operation command 1101 using the data retrieval circuit 1202, the data search circuit 1203, the search condition joining circuit 1204, and the data extraction circuit 1205, and sets the information in the respective circuits.

The command setting unit 1201 sets in the data retrieval circuit 1202 the byte positions of the row data to be compared, which is stored in the data search conditions 1106-1 to 1106-N in the database operation command 1101.

The command setting unit 1201 extracts the comparison methods of the row data to be compared, which is stored in the data search conditions 1106-1 to 1106-N in the database operation command 1101, and then sets the comparison methods in the data search circuit 1203. The row data comparison method is, for example, a group of large/small comparison conditions and comparison values. The command setting unit 1201 sets in the search condition joining circuit 1204 the search condition joining methods 1107-1 to 1107-N in the database operation command 1101. Here, the joining method is, for example, a method of joining search conditions by AND or OR such as in the following statement: (first condition) AND (second condition) OR (third condition).

The command setting unit 1201 sets in the data extraction circuit 1205 the data extraction conditions 1108-1 to 1108-N in the database operation command 1101. Here, the data extraction conditions 1108-1 to 1108-L include conditions for retrieving data from the row data such as from the 0th byte to the 7th byte or from the 15th byte to the 23rd byte, for example.

The row data storage memory 1206 stores row data received from the database operation control unit 81. The row data storage memory 1206 is referred to by the data retrieval circuit 1202 and the data extraction circuit 1205 as necessary.

The data retrieval circuit 1202 starts the process when it receives a command to start the operation from the database operation control unit 81. The data retrieval circuit 1202 retrieves data from the row data storage memory 1206 on the basis of the byte positions of the row data to be compared, which is stored in the data search conditions 1106-1 to 1106-N in the database operation command 1101, and transmits the data to the data search circuit 1203.

The data search circuit 1203 determines whether the data received from the data retrieval circuit 1202 matches conditions on the basis of the row data comparison method, and transmits the determination results for whether the data matches the conditions to the search condition joining circuit 1204.

The search condition joining circuit 1204 joins the determination results received from the data search circuit 1203 on the basis of the search condition joining methods 1107-1 to 1107-M, and transmits the determination results to the data extraction circuit 1205. The data extraction circuit 1205 does not perform processing if the determination result received from the search condition joining circuit 1204 is false. If the determination result received from the search condition joining circuit 1204 is true, then the data extraction circuit 1205 extracts data from the row data storage memory 1206 according to the data extraction conditions 1108-1 to 1108-L, and transmits the extracted data to the database operation control unit 81.

In the present embodiment, an example was illustrated in which the database operation circuit 70 is implemented with hardware, but the database operation circuit 70 can also be implemented by a program executed by the CPU 40. In such a case, the CPU 40 executes a database operation program loaded to the memory 50, and functions as the database operation unit.

As described above, according to Embodiment 1, by the database operation module 108 dividing the read-in operation of a prescribed area of the flash module 105 including a plurality of flash memories 107 into READ access operations of small areas, it is possible to speed up the read-in operation in the flash module 105.

Furthermore, by the database operation module 108 issuing a READ command for the plurality of flash modules 105, it is possible to speed up the read-in process among the flash modules 105.

By the database operation module 108 executing database operations in succession starting with data for which the read-in process has been completed, it is possible to speed up the database operation while decreasing overhead resulting from pending data.

Also, according to Embodiment 1, by separating the flash modules 105-1 to 105-n and the database operation modules 108-1 to 108-n, it is possible to appropriately select whether to transmit the command from the DBMS 102 to the flash module 105 or the database operation module 108 according to the database processing content.

According to Embodiment 1, in order to improve performance in a configuration in which the flash module 105 is separated from the database operation module 108, it is possible to appropriately schedule commands to be sent to the flash module 105 and commands to be sent to the database operation module 108.

Also, according to Embodiment 1, the flash module 105 is separated from the database operation module 108, and the reset circuits 109 and 91 and the power source control units 110 and 92 are provided, respectively, in the flash module 105 and the database operation module 108. In this manner, it is possible to reset or stop modules where a malfunction has occurred, thereby improving redundancy. In this manner, it is possible to improve database processing performance while ensuring redundancy.

In Embodiment 1, when the READ command to the access area of the flash module 105 was completed, the database operation circuit 70 executed the database operation, but the database operation circuit 70 may execute the database operation when the READ commands to the small areas of the flash module 105 are completed.

### Embodiment 2

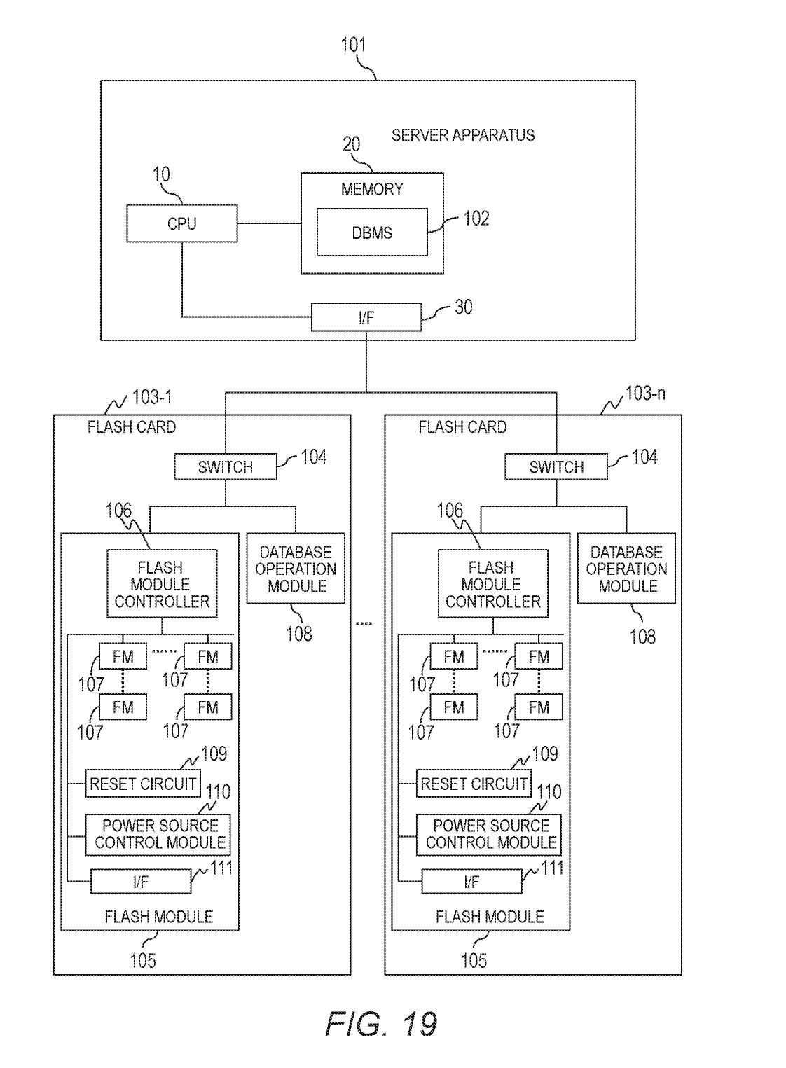

FIG. 19 shows Embodiment 2, and is a block diagram showing one example of a computer system that includes flash cards. In Embodiment 1, an example was illustrated in which each flash card 103 is provided with a switch 104, a plurality of flash modules 105, and a plurality of database operation modules 108. By contrast, in Embodiment 2, it is possible to install the switch 104, the flash module 105, and the database operation module 108 as separate cards.

In each of the flash cards 103-1 to 103-n of Embodiment 2, the database operation module 108 and the flash module 105 of Embodiment 1 are installed in a one-to-one configuration and connected to each other by the switch 104, and the plurality of flash cards 103-1 to 103-n are connected to an interface 30. The interior of the flash cards 103-1 to 103-n is similar to that of Embodiment 1, and the database operation module 108 and the flash module 105 are connected to the switch 104.

According to Embodiment 2, it is possible to adjust the processing performance of the database according to the number of flash cards 103 provided in the server apparatus 101.

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid state drive (SSD), or on a recording medium such as an IC card, an SD card, or a DVD.

The control lines and information lines described are lines that a re deemed necessary for the description of this invention, and not all of control lines and information lines of a product are mentioned. In actuality, it can be considered that almost all components are coupled to one another.

What is claimed is:

1. A computer that provides a database management unit that manages a database, the computer comprising:
a processor;
a memory; and
a device connected to the processor through an interface,
wherein the device comprises:
a non-volatile semiconductor storage device including a plurality of non-volatile semiconductor memories, and storing the database;
a database operation module that reads in the database from the non-volatile semiconductor storage device and performs an operation on the database; and
a switch that connects the interface with the non-volatile semiconductor storage device and the database operation module.

2. The computer according to claim 1,
wherein the device includes a plurality of the non-volatile semiconductor storage devices and a plurality of the database operation modules,
wherein the database management unit further comprises database operation module information that sets a relationship of a non-volatile semiconductor storage device, from among the plurality of non-volatile semiconductor storage devices, that can be accessed by the database operation module, and
wherein, when the database management unit receives a search request for the database, the database management unit determines whether to perform a complete search by which the non-volatile semiconductor storage device to be accessed in the search request reads in an entirety of the database, or a partial search by which the database is partially read in, and selects the database operation module or the non-volatile semiconductor storage device to be used from the database operation module information according to the determination results.

3. The computer according to claim 2,
wherein, if the search request for the database is for the complete search, the database management unit refers to the database operation module information and determines the non-volatile semiconductor storage device and the database operation module that can access the database to be searched, and issues a database operation command to the determined database operation module to execute a search in a area to be accessed of the non-volatile semiconductor storage device,
wherein the database operation module receives the database operation command, divides the area to be accessed of the non-volatile semiconductor storage device into prescribed small areas, generates a READ command for each of the divided plurality of small areas, and transmits a plurality of the READ commands to the non-volatile semiconductor storage device, and
wherein the non-volatile semiconductor storage device receives the READ command for each of the plurality of small areas and reads in data from the plurality of non-volatile semiconductor memories in parallel.

4. The computer according to claim 3,
wherein, when the READ commands for the respective plurality of small areas are completed, the non-volatile semiconductor storage device transmits the read-in data to the database operation module, and
wherein the database operation module executes the database operation in the order of completion of reading corresponding to the database operation command, and issues results of the database operation as a notification to the database management unit.

5. The computer according to claim 4,
wherein the database operation module has set therein, in advance, a command execution multiplicity that is an upper limit value of a number of the database operation commands that can be executed simultaneously, the database operation module being able to receive a plurality of the database operation commands from the database management unit, the database operation module suspending execution of database operation commands that exceed a value set for the command execution multiplicity, and starting execution of the database operation commands for which execution was suspended after prior database operation commands have been processed.

6. The computer according to claim 5,
wherein the database management unit further comprises:
table area management information of the non-volatile semiconductor storage device where the database on which the operation is to be performed is stored; and
information of the command execution multiplicity of the database operation module,
wherein, with reference to the table area management information, the information of the command execution multiplicity, and the database operation module information, the database management unit performs scheduling of the database operation commands transmitted to the database operation module, and generates the database operation commands on the basis of the scheduling.

7. The computer according to claim 2,
wherein the database management unit determines whether to perform the complete search or the partial search according to a presence or absence of index information of the database stored in the non-volatile semiconductor storage device.

8. The computer according to claim 4,
wherein the database operation module further includes a database operation circuit that executes the database operation, and
wherein the database operation module causes the database operation circuit to execute the database operation in the order of completion of reading corresponding to the database operation command, acquires operation results from the database operation circuit, and issues the operation results as a notification to the database management unit.

9. A database management method by which a computer that comprises a processor and a memory, and that provides a database management unit, manages a database,
wherein the computer comprises a device connected to the processor through an interface,
wherein the device comprises a non-volatile semiconductor storage device including a plurality of non-volatile semiconductor memories and storing the database, a database operation module that reads in the database from the non-volatile semiconductor storage device and performs an operation on the database, and a switch that connects the interface to a plurality of the non-volatile semiconductor storage devices and a plurality of the database operation modules, and
wherein the management method comprises:
a first step in which the database management unit receives a search request for the database;
a second step in which the database management unit determines whether to perform a complete search by which the non-volatile semiconductor storage device to be accessed in the search request reads in an entirety of the database, or a partial search by which the database is partially read in; and
a third step in which the database management unit refers to database operation module information that sets a relationship of a non-volatile semiconductor storage device, from among the plurality of non-volatile semiconductor storage devices, that can be accessed by the database operation module, and selects the database operation module or the non-volatile semiconductor storage device to be used from the database operation module information according to the determination results.

10. The database management method according to claim 9, further comprising:
a fourth step in which, if the search request for the database is for the complete search, the database management unit refers to the database operation module information and determines the non-volatile semiconductor storage device and the database operation module that can access the database to be searched;
a fifth step in which the database management unit issues a database operation command to the determined database operation module to execute a search in a area to be accessed of the non-volatile semiconductor storage device;
a sixth step in which the database operation module receives the database operation command, divides the area to be accessed of the non-volatile semiconductor storage device into prescribed small areas, generates a READ command for each of the divided plurality of small areas, and transmits a plurality of the READ commands to the non-volatile semiconductor storage device; and
a seventh step in which the non-volatile semiconductor storage device receives the READ command for each of the plurality of small areas and reads in data from the plurality of non-volatile semiconductor memories in parallel.

11. The database management method according to claim 10, further comprising:
an eighth step in which, when the READ commands for the respective plurality of small areas are completed, the non-volatile semiconductor storage device transmits the read-in data to the database operation module;
a ninth step in which the database operation module executes the database operation in the order of completion of reading corresponding to the database operation command; and
a tenth step in which the database operation module issues results of the database operation to the database management unit as a notification.

12. The database management method according to claim 11,
wherein the database operation module has set therein, in advance, a command execution multiplicity that is an upper limit value of a number of the database operation commands that can be executed simultaneously, the database operation module being able to receive a plurality of the database operation commands from the database management unit, and
wherein, in the ninth step, execution is suspended for database operation commands that exceed a value set for the command execution multiplicity, and execution is started for the database operation commands for which execution was suspended after prior database operation commands have been processed.

13. The database management method according to claim 12,
wherein the database management unit further comprises:
table area management information of the non-volatile semiconductor storage device where the database on which the operation is to be performed is stored; and
information of the command execution multiplicity of the database operation module, and
wherein, in the fifth step, with reference to the table area management information, the information of the command execution multiplicity, and the database operation module information, the database management unit performs scheduling of the database operation commands transmitted to the database operation module, and generates the database operation commands on the basis of the scheduling.

14. The database management method according to claim 9,
wherein, in the second step, a determination is made on whether to perform the complete search or the partial search according to a presence or absence of index information of the database stored in the non-volatile semiconductor storage device.

15. The database management method according to claim 11,
wherein the database operation module further includes a database operation circuit that executes the database operation, and
wherein, in the ninth step, the database operation module causes the database operation circuit to execute the database operation in the order of completion of reading corresponding to the database operation command, and
wherein, in the tenth step, the database operation module acquires operation results from the database operation circuit, and issues the operation results as a notification to the database management unit.
